(19) United States
(12) Patent Application Publication
(10) Pub. No.: US 2010/0202852 A1
(43) Pub. Date: Aug. 12, 2010

(54) No-tools panel coupler and insert

(76) Inventors: Steven T. Krause, Rancho Santa Margarita, CA (US); Thomas B. Hazzard, Ladera Ranch, CA (US); Kurt A. Berlin, Anaheim, CA (US)

Correspondence Address: Morland C. Fischer, Suite 1300, 2030 Main Street, Irvine, CA, 92614, US

(21) Appl. No.: 12/322,831

(22) Filed: Feb. 9, 2009

(51) Int. Cl. F16B 39/30; A47B 47/04

(52) U.S. Cl. 411/272; 312/263

(57) ABSTRACT

A coupler to be embedded in a first (e.g., flat) panel and an insert to be embedded in a second (e.g., flat) panel to be joined to the first panel during the assembly of an article, for example, of furniture. The coupler includes a coupler body, a cam bolt rotatable within the coupler body, a cam head carried by and rotatable with the cam bolt, and a lever extending from the cam bolt to a location outside the coupler body at which to receive a rotational pushing force. The insert has a hollow interior, a closed leading end extending laterally across the hollow interior, and a window formed in the closed leading end and communicating with the hollow interior. The cam head of the coupler is moved through the window in the closed leading end of the insert. A rotational force applied to the lever causes the cam bolt to rotate within the coupler body, which rotation is imparted to the cam head. The cam head is correspondingly rotated at the hollow interior of the insert so as to move out of alignment with the window in the closed leading end thereof to be relocated below the closed leading end. Accordingly, the coupler and the insert are connected in mating interlocking engagement with one another, whereby the first and second panels will be joined to one another without the use of tools or additional hardware fasteners.

### BACKGROUND OF THE INVENTION

1. Field of the Invention

This invention relates to a coupler and insert combination which cooperate to join a pair of (e.g., flat) panels of the type used during the assembly of an article of furniture. By virtue of the combination disclosed herein, the article of furniture may be quickly and easily assembled by an end user without the use of tools or additional fastening hardware and without special skill requirements.

2. Background Art

Articles of furniture are often shipped in a fully-assembled condition from a manufacturer to a retailer and then carried off by an end user to a home or office. Consequently, such an article of furniture is characteristically bulky, cumbersome and difficult to transport in a space-efficient manner. That is to say, a fully-assembled article of furniture consumes relatively large shipping space during transport by boat, truck, etc. to a retailer. Similarly, the purchaser/end user may need to have available a specially-sized vehicle should he wish to carry a large article of furniture to his home or office. The inefficient shipment of large articles of furniture between the manufacturer and end user often results in inconvenience as well as higher transportation costs which are commonly passed through to the purchaser.

To overcome the aforementioned disadvantages, it is known to ship articles of furniture disassembled. In this case, the end user is typically required to have available and be able to use at least some tools and hardware provided by the manufacturer in order to complete the furniture assembly. Sometimes, the user may not have the skill required to use the tools with the hardware which may consequently hinder the user's ability to easily assemble and immediately enjoy his furniture. In other cases, the user may lack time and become frustrated which can result in his failure to complete the assembly altogether. Thus, the article of furniture may remain disassembled and eventually have to be returned to the point of purchase.

Accordingly, it would be desirable to have a coupler that is adapted to join a pair of panels so that an article of furniture may be quickly and easily assembled by the end user without requiring special skill or the use of tools or additional hardware.

### SUMMARY OF THE INVENTION

Briefly, disclosed herein is the combination of a coupler and an insert to be connected together so that pairs of (e.g., flat) panels can be joined to one another to enable an end user to construct, for example, an article of furniture that is packaged and shipped in a disassembled condition. One or more couplers are embedded in respective coupler cavities formed in a first panel of a pair of the panels to be joined together, and one or more inserts are embedded in respective insert cavities that are formed in the second panel of the pair of panels. By connecting the couplers to the inserts, the pair of panels can be joined in end-to-end perpendicular alignment without the use of tools or additional hardware and without special skill requirements. “No tools” articles of furniture which can be constructed in this manner include, but are not limited to, a desk, table, bookcase, TV stand, and the like.

Each coupler that is embedded in the first panel includes a coupler body having a pair of coupler body halves that are attached to one another along a living hinge, whereby the coupler body halves are rotatable relative to one another between an open position and a closed position. In the open position, the coupler body halves are rotated away from one another to establish cradles for receipt of a cam bolt. In the closed position, the coupler body halves are rotated towards one another to completely surround and support the cam bolt so that the cam bolt can slide axially along and rotate within the cradles. An upstanding lever projects radially from the cam bolt and outwardly from the coupler body so as to be manually accessible to receive both axial and rotational pushing forces to be applied by the user. A cam head is formed at one end of the cam bolt. The cam head is adapted to be mated to an insert that is embedded in the second panel to be joined to the first panel during construction of the article of furniture. The cam head of the cam bolt is initially located inwardly of the coupler body prior to assembly. An axial pushing force applied by the user to the lever causes the cam bolt to slide axially along the cradles of the coupler body halves so that the cam head is pushed outwardly from the coupler body in order to be mated to the insert.

Each insert has a hollow body and closed leading end. A window is formed through the closed leading end of the insert which communicates with the hollow interior thereof. A coupler embedded in a first panel is moved into mating interlocking engagement with an insert embedded in the second panel by first sliding the cam head of the cam bolt of the coupler through the window in the closed leading end of the insert. A rotational force is then applied by the user to the lever of the cam bolt to cause the cam bolt to rotate in the cradles of the coupler body. This rotation of the cam bolt is imparted to the cam head which correspondingly rotates at the interior of the insert. As a result of this rotation, the cam head is moved out of alignment with the window so as to reside below the closed leading end of the insert. Removal of the cam head from the insert is now blocked by the closed leading end of the insert, whereby the coupler cannot be disengaged from the insert. The cam head of the cam bolt has a square cam shoulder which is rotated over the closed leading end of the insert to pull the insert towards the coupler. Accordingly, the pair of panels will be held tightly together to enable the article of furniture to be quickly and easily assembled without the use of tools or other fasteners.

### BRIEF DESCRIPTION OF THE DRAWINGS

FIGS. 1 and 2 are exploded views showing a pair of adjacent panels to be joined to one another by means of connecting a coupler to an insert according to the present invention;

FIGS. 3 and 4 show the pair of panels joined end-to-end one another following the connection of the coupler to the insert of FIGS. 1 and 2 during the assembly of an article of furniture, or the like;

FIGS. 5-9 show details of each of the coupler and insert according to a preferred embodiment by which the pair of panels of FIGS. 1-4 are joined together;

FIGS. 10 and 11 show the opposing leading and trailing ends of the insert as a cam head of the coupler is moved into mating engagement with the insert by way of a window formed through the leading end thereof;

FIGS. 12 and 13 show the opposing leading and trailing ends of the insert after the cam head from the coupler has been rotated relative to the window formed through the leading end of the insert in order to prevent a disengagement of the coupler from the insert;

FIGS. 14 and 15 show the coupler with the cam head initially located inwardly of the body of the coupler;

FIG. 16 shows the position of the cam head after it has been advanced outwardly from the body of the coupler and aligned to be moved into mating engagement with the insert by way of the window formed through the leading end thereof;

FIG. 17 shows the position of the cam head after being rotated within the insert relative to the window through the leading end thereof so as to prevent a disengagement of the coupler from the insert; and

FIGS. 18-20 illustrate details of the cam head by which the cam head is rotated into mating interlocking engagement with the insert, whereby to connect the coupler to the insert.

### DESCRIPTION OF THE PREFERRED EMBODIMENT

A preferred embodiment for a combination coupler 1 and insert 46 which forms the present invention is initially described while referring concurrently to FIGS. 1-4 of the drawings. The coupler 1 and insert 46 herein disclosed have particular application for enabling a pair of (e.g., flat) panels, walls, sides, and the like to be quickly and reliably joined to one another without requiring special skill or the use of tools or additional hardware. In this case, the coupler 1 cooperates with the insert 46 to hold the pair of panels in perpendicular alignment so as to be interconnected with additional panels, walls, sides, etc. by which to facilitate the construction of a three-dimensional article. By way of particular example, but without creating a limitation of this invention, articles which may be assembled by a plurality of flat panels that are interconnected with one another by means of a plurality of the coupling systems of this invention including coupler 1 and insert 46 are those common to the furniture industry. Such articles of furniture may include a desk, table, book case, and TV stand to name but a few. By virtue of the foregoing, an article of furniture may be shipped in a generally flat, disassembled configuration in one or more compact shipping containers so as to advantageously reduce shipping costs and permit the article to be more easily and efficiently transported from the point of purchase to the location of ultimate assembly and use without requiring a specially sized vehicle.

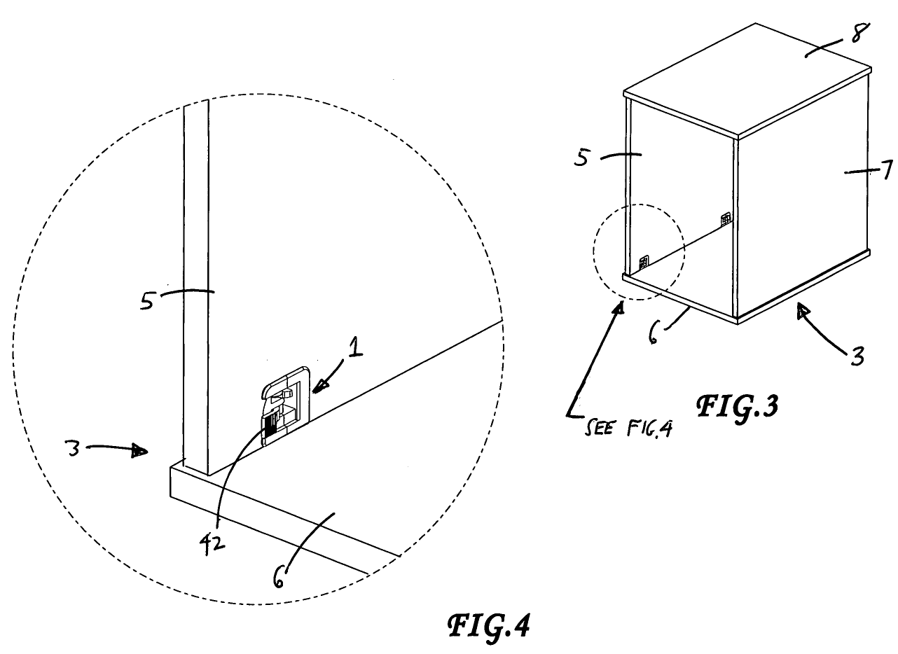

In the example of FIGS. 1-4, a number of coupler 1 and insert 46 combinations are used to join pairs of perpendicularly-aligned panels 5, 6, 7 and 8 end-to-end another so that a frame 3 (best shown in FIG. 3) can be assembled without the use of tools or additional fastening hardware. To accomplish the foregoing frame construction, one panel (e.g., 5) from a pair of adjacent, perpendicularly-aligned panels (e.g., 5 and 6) includes a coupler cavity 10 formed therein and ideally located adjacent each corner thereof. Where the one panel 5 is rectangular, as shown, a total of four coupler cavities 10 are required with respect to the four corners thereof. The coupler cavities 10 are preferably cylindrical to accommodate similarly shaped, soon-to-be-described coupler bodies 20. Each coupler cavity 10 intersects the top or bottom of the panel 5 in which the couplers 1 will be inserted so that the panels 5 and 6 can ultimately be joined to make a tight fit therebetween.

The second panel (e.g., 6) from the pair of adjacent, perpendicularly-aligned panels 5 and 6 which are to be joined together to create the frame 3 includes an insert cavity 12 formed therein and ideally located adjacent each corner thereof. Where the second panel 6 is rectangular, as shown, a total of four insert cavities 12 are required with respect to the four corners thereof. The insert cavities 12 are preferably cylindrical to accommodate the similarly shaped, soon-to-be-described inserts 46. The insert cavities 12 are spaced inwardly from the corners of the second panel 6 such that in the assembled frame configuration (of FIGS. 3 and 4), the insert cavities 12 of panel 6 lie in vertical planar alignment with respective ones of the coupler cavities 10 formed in the first panel 5.

The second panel 6 also includes pin holes 16 located adjacent each of the insert cavities 12. In the example of FIGS. 1-4, the second panel 6 has a total of four pin holes 16 formed therein located adjacent four insert cavities 12. Each pin hole 16 is sized to receive a dowel pin (not shown). With the panels 5 and 6 joined in end-to-end perpendicular alignment to one another as shown in FIGS. 3 and 4, a pair of dowel pins which project from the pin holes 16 in the second panel 6 are received in oppositely-aligned pin holes (also not shown) formed in the bottom of the first panel 5. The connection of dowel pins between the adjacent first and second panels 5 and 6 helps to preserve the perpendicular alignment of the panels and an inadvertent separation thereof.

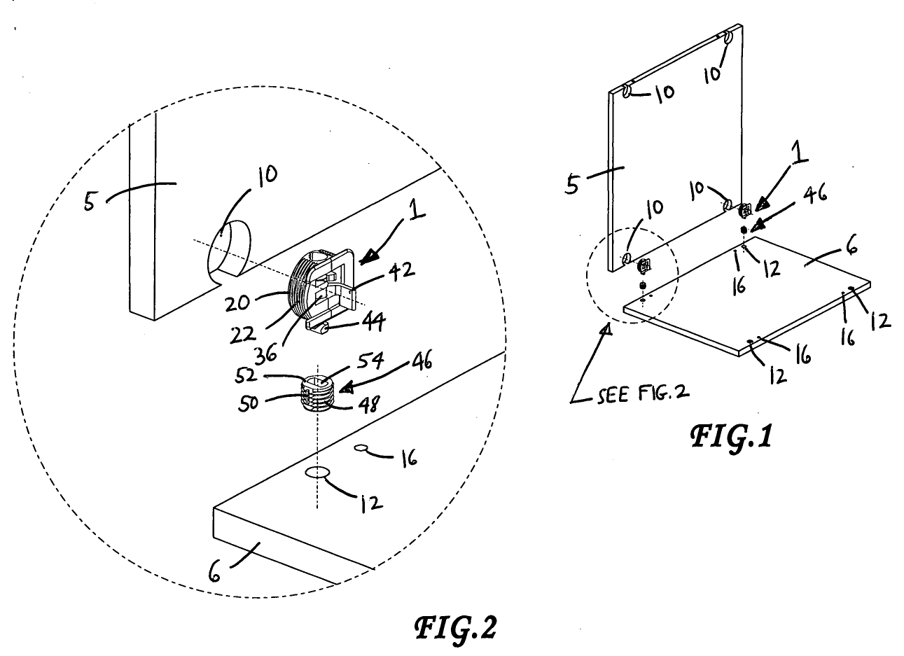

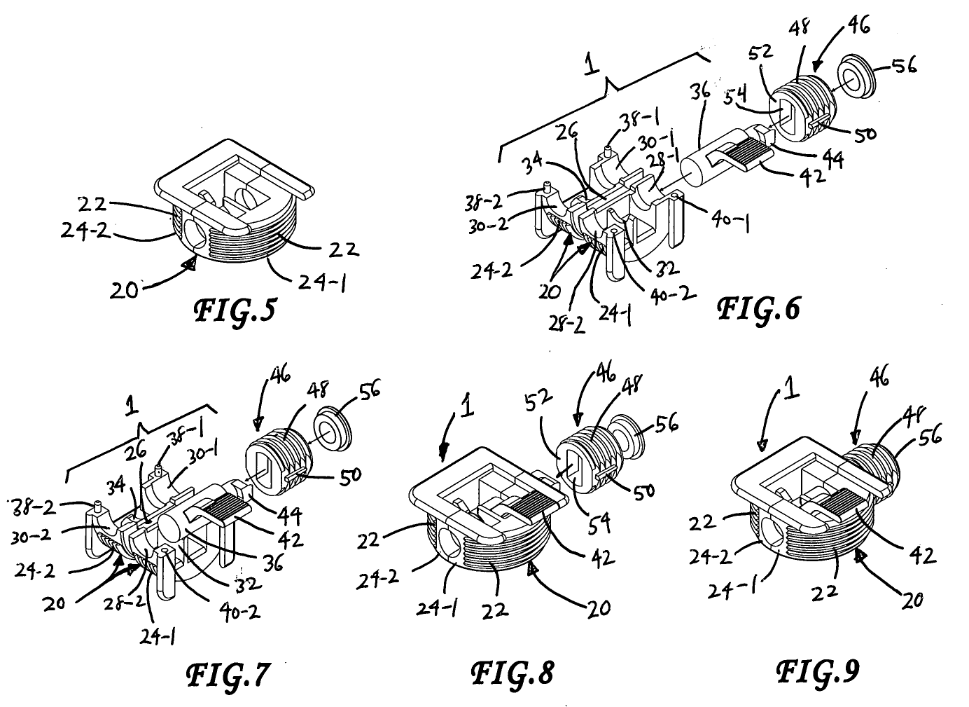

Turning now to FIGS. 5-9 of the drawings, details of the coupler 1 and the insert 46 of FIGS. 1-4 are now disclosed. The coupler 1 has a cylindrical coupler body 20 that is sized and shaped to be embedded within a cylindrical coupler cavity 10 formed at a corner of the first panel 5 (best illustrated in FIG. 2). The coupler body 20 has a set of generally sharp, circumferentially-running teeth or ribs 22 that bite into and grip the first panel 5 so as to hold the coupler body 20 in place after a rotational force has been applied to the coupler 1 by the manufacturer to cause the body 20 thereof to rotate inwardly of the coupler cavity 10.

The body 20 of coupler 1 has a pair of body halves 24-1 and 24-2 that are pivotally coupled to one another along a living hinge 26. To this end, the coupler 1 is preferably manufactured from a suitable (e.g., injected polypropylene or injected molded plastic) material so that the coupler body halves 24-1 and 24-2 can rotate relative to one another at the living hinge 26 lying therebetween from a closed position disposed in opposite facing alignment (best shown in FIGS. 5, 8 and 9) to an open position disposed side-by-side one another (best shown in FIGS. 6 and 7).

As is best shown in FIG. 6, each half 24-1 and 24-2 of the coupler body 20 between which the living hinge 26 extends has a pair of arcuate cam bolt support lips 28-1, 28-2 and 30-1, 30-2 located at opposite ends thereof. Each coupler body half 24-1 and 24-2 also has an arcute cam bolt support stand 32 and 34 located about midway between respective pairs of support lips 28-1, 28-2 and 30-1, 30-2. In the open position of the coupler body 20 shown in FIG. 6, the pairs of cam bolt support lips 28-1, 28-2 and 30-1, 30-2 and the cam bolt support stands 32 and 34 located therebetween are axially aligned to establish first and second cradles to surround and embrace a cylindrical cam bolt 36 therewithin (best shown in FIG. 7).

The cam bolt 36 of coupler 1 is laid into one of the cradles established by one of the coupler body halves 24-1 and 24-2 when the coupler body halves are rotated apart from one another at hinge 26 to the open position. The coupler body halves 24-1 and 24-2 are then rotated towards one another to the closed position such that the cradles thereof fully surround and support the cam bolt 36 so that the cam bolt 36 can slide axially therealong and rotate therewithin (best shown in FIG. 8). That is, when the coupler body 20 has been closed, the cylindrical cam bolt 36 will be surrounded by a first of the cradles established by the cam bolt support lips 28-1 and 28-2 and the cam bolt support stand 32 of one coupler body half 24-1 and the second cradle established by the cam bolt support lips 30-1 and 30-2 and the cam bolt support stand 34 of the other coupler body half 24-2. To this end, one of the coupler body halves (e.g., 24-2) has a pair of locking pins 38-1 and 38-2 projecting from opposite ends thereof. The other one of the coupler body halves 24-1 has a pair of pin holes 40-1 and 40-2 formed therein. When the halves 24-1 and 24-2 of the coupler body 20 are rotated to the closed position, the locking pins 38-1 and 38-2 of the coupler body half 24-1 are correspondingly rotated into receipt of the pin holes 40-1 and 40-2 of the coupler body half 24-1 so as to hold the coupler body 20 in the closed position with the cam bolt 36 surrounded and supported by the opposing cradles established by the coupler body halves 24-1 and 24-2.

The cam bolt 36 (best shown in FIG. 6) of coupler 1 is preferably manufactured from metal. A lever 42 projects radially from approximately the midpoint of cam bolt 36. A cam head 44 is formed at one end of the cam bolt 36. When the body 20 of the coupler 1 is in the closed position (of FIG. 8) so that the cam bolt 36 is cradled between the halves 24-1 and 24-2 of coupler body 20, the lever 42 will be manually accessible to receive user applied axial and rotational pushing forces thereagainst. More particularly, and as will be disclosed when referring to FIGS. 14-17, the cam head 44 at one end of the cam bolt 36 is initially located inwardly of the body 20 of coupler 1. This is particularly advantageous, because the cam head 44 will not protrude from the body 20 where it could interfere with an efficient arrangement of the furniture panels 5-8 (of FIG. 3) within a compact shipping package.

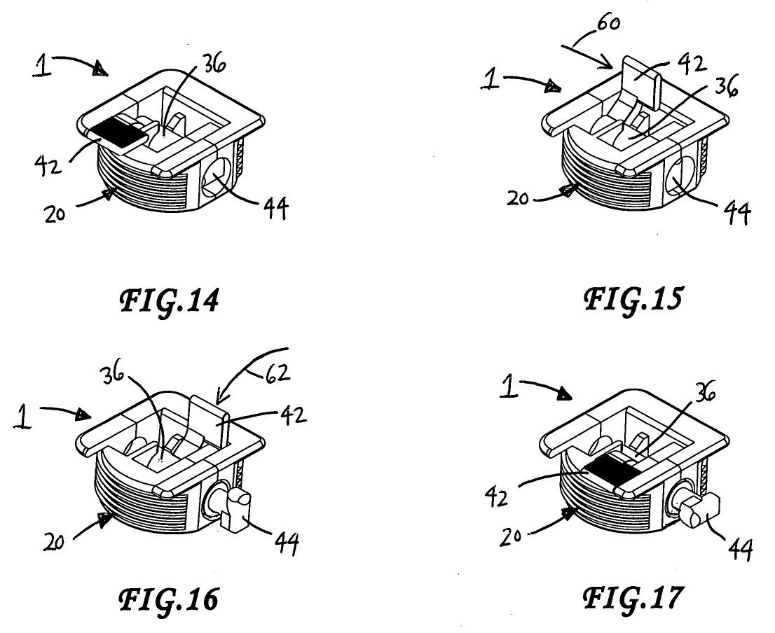

When it is desirable to connect the coupler 1 to an insert 46 during assembly of the article of furniture so that the panels 5 and 6 (of FIGS. 1 and 2) can be joined together, an axial pushing force is applied to the lever 42 of the cam bolt 36 in the direction of the reference arrow 60 of FIG. 15 to push the cam head 44 outwardly of the coupler body 20. The cam head 44 will then be available to be be rotated into mating engagement with the insert 46 in response to a rotational pushing force applied to the lever 42 of cam bolt 36 in the direction of the reference arrow 62 of FIG. 16.

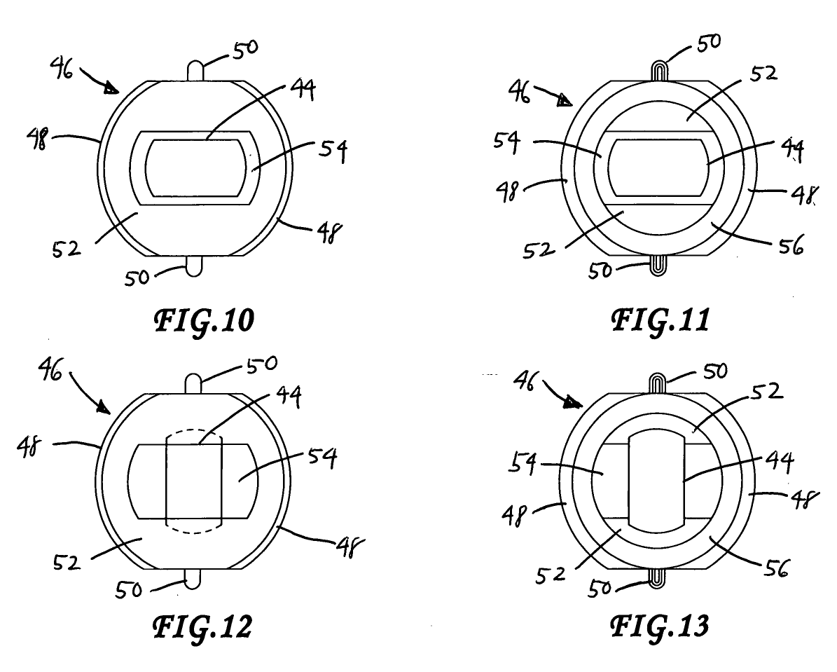

To enable the coupler 1 (of panel 5) to be connected to the insert 46 (of panel 6), the insert 46 is provided with a hollow cylindrical body that is sized to accommodate the cam head 44 of cam bolt 36. Insert 46 is preferably manufactured (e.g., molded) from the same material and by the same method used to manufacture the body 20 of coupler 1. The insert 46 has a set of generally sharp ribs 48 running circumferentially therearound. The ribs 48 will bite into and grip the panel 6 to be joined to the adjacent panel 5 to hold the insert 36 in place after the insert has been embedded by the manufacturer in an insert cavity 12 (of FIG. 2) formed in panel 6. The insert 36 also has a pair of ribs 50 (best shown in FIGS. 10-13) running longitudinally therealong and located at opposite sides thereof. The longitudinally-running ribs 50 prevent a rotation of the insert 46 within the insert cavity 12 of panel 6 in response to a rotation of the cam bolt 36 and the cam head 44 thereof while the cam head 44 and insert 46 are being mated to one another.

Turning now to FIGS. 10-13 of the drawings, the cylindrical insert 46 is shown having a leading end 52 (best shown in FIGS. 10 and 12) that is closed except for a generally rectangular window 54 formed therein. The window 54 is sized and shaped to enable the cam head 44 of the cam bolt 36 of FIGS. 5-9 to move inwardly past the closed leading end 52 for receipt by and rotation within the hollow interior of insert 46. The opposite trailing end 56 of insert 46 (best shown in FIGS. 11 and 13) is open. An end cap (designated 58 in FIGS. 5-9) is press-fit against the insert 46 to close the trailing end 56 thereof.

The connection of the coupler 1 to the insert 46 and the rotation of the cam head 44 of cam bolt 36 relative to the leading end 52 of insert 46 are now described while referring concurrently to FIGS. 10-17 of the drawings. As was earlier explained, in its as-packaged configuration, the cam head 44 of the cam bolt 36 is initially located inwardly of the body 20 of coupler 1 (best shown in FIG. 14). The lever 42 which projects radially from the cam bolt 36 is raised (i.e., rotated) from its as-packed horizontal position (of FIG. 14) lying against the coupler body 20 to an upstanding vertical position (best shown in FIG. 15). An axial pushing force is then applied by the user to the upstanding lever 42 (in the direction of the reference arrow 60 of FIG. 16), whereby to cause the cam bolt 36 to correspondingly slide axially through the coupler body 20 and the cam head 42 to be relocated outwardly of the coupler body 20.

The cam head 42 of the cam bolt 46 of coupler 1 is now available to be mated to the insert 46. That is to say, the cam head 42 stands vertically outward from the coupler body 20 so as to be aligned for movement inwardly through the open window 54 in the leading end 52 of the insert 46 for receipt at the hollow interior thereof (best shown in FIGS. 10 and 11). A rotational pushing force applied by the user to the lever 42 in the direction of the reference arrow 62 of FIG. 16 causes the lever to rotate 90 degrees from its upstanding vertical position of FIG. 16 back to its initial horizontal position (best shown in FIG. 17). Accordingly, the cam bolt 36 that is cradled between the halves 24-1 and 24-2 of the body 20 of the coupler 1 will also rotate 90 degrees. This rotation of the cam bolt 36 is imparted to the cam head 42 to cause the cam head 42 to also rotate below the leading end 52 of insert 46 from its initial vertical position of FIG. 16 to a horizontal position of FIG. 17.

It may be appreciated that following the rotation of the lever 42 of cam bolt 36 in response to the pushing force 62, the cam head 44 of cam bolt 36 will be rotated out of alignment with the window 54 so as to reside below the closed leading end 52 of insert 46 (best shown in FIGS. 12 and 13). Because its removal will now be blocked by the closed leading end 52, the cam head 44 of cam bolt 36 of coupler 1 cannot be pulled outwardly through the window 54 and separated from the insert 46 whereby the coupler 1 and insert 46 are coupled in interlocking engagement. Inasmuch as the coupler 1 is embedded within the panel 5 at a coupler cavity 10 (as shown in FIGS. 1-4) and the insert 46 is embedded within the adjacent panel 6 at an insert cavity 12 (also shown in FIGS. 1-4), the pair of panels 5 and 6 will be reliably joined together as part of the construction of the frame 3. Any other couplers 1 and inserts 46 from the panels 5 and 6 are connected to one another in an identical manner to that just described. As earlier explained, the aforementioned connection of panels 5 and 6 is advantageously accomplished without the use of tools or any additional hardware fasteners.

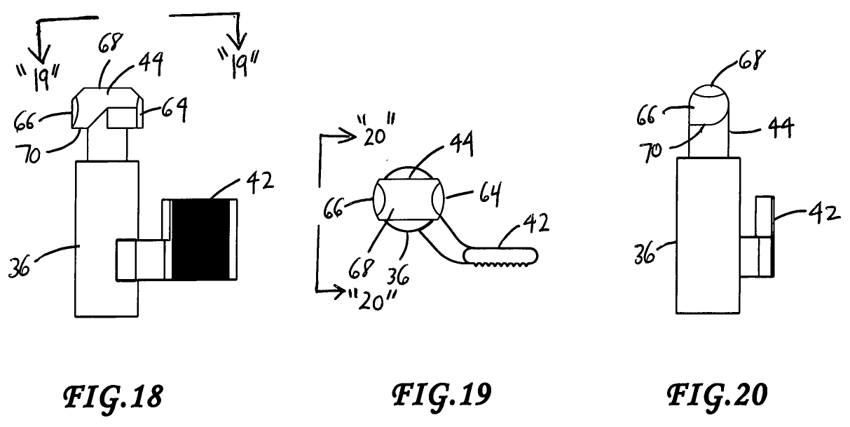

FIGS. 18-20 of the drawings illustrate details of the cam head 44 of the cam bolt 36 of the coupler 1. As just described, the cam head 44 is rotated into mating interlocking engagement with the insert 46 such that the coupler is connected to the insert 46 and the panel 5 is joined to the adjacent panel 6. To facilitate the foregoing, the cam head 44 is provided with radiused (convex) surfaces 64 and 66 at opposite sides thereof, a rounded self-aligning top 68, and a flat (i.e., square) bottom 70.

The radiused end surfaces 64 and 66 guide the cam head 44 during its rotation around the interior of the hollow cylindrical insert in response to the rotational pushing force (designated 62 in FIG. 16) applied to the lever 42 of cam bolt 36, whereby the cam head 44 will be located below the closed leading end 52 of insert 46 (best shown in FIGS. 12 and 13) to prevent a separation of the coupler 1 from the insert 46. The rounded top 68 (best shown in FIG. 20) helps align the cam head 44 for receipt through the window 54 formed in the closed leading end 52 of the insert 46. The flat bottom 70 (best shown in FIG. 18) provides a square cam shoulder which rides over the closed leading end 52 of insert 46 to apply a pulling force against the insert 56 and the panel 6 within which the insert is embedded. By virtue of the foregoing, the adjacent panels 5 and 6 to be joined together will be pulled towards and held tightly against one another.

1. For joining first and second panels together without the use of tools, a combination comprising:
a coupler to be connected to the first panel and including a coupler body, a locking head, and a locking head position control communicating with said locking head; and
an insert to be connected to the second panel and including a locking end at which to receive and retain the locking head of said coupler when said coupler is moved towards and into engagement with said insert and the locking head position control of said coupler is operated to cause the locking head of said coupler to move with respect to the locking end of said insert from an unlocked position to a locked position, whereby said coupler is mated to said insert so that the first panel is joined to the second panel.

2. The combination recited in claim 1, wherein the locking head of said coupler is carried by a locking bolt located within the body of said coupler, said locking head position control communicating with said locking bolt and adapted to receive a force thereagainst for operating said locking head position control and thereby causing said locking bolt to move within said coupler body and said locking head to correspondingly move with respect to the locking end of said insert from said unlocked position to said locked position.

3. The combination recited in claim 2, wherein the locking head carried by said locking bolt is located inwardly of the body of said coupler, said locking bolt sliding through the body of said coupler in response to the force applied against the locking head position control communicating with said locking bolt, whereby to cause said locking head to correspondingly move outwardly from said coupler body at which to be moved from said unlocked position to said locked position after said coupler is moved into engagement with said insert.

4. The combination recited in claim 2, wherein said locking bolt is rotatable within the body of said coupler when the force applied against the locking head position control is a rotational force, whereby to cause said locking head carried by said locking bolt to correspondingly rotate with respect to the locking end of said insert from said unlocked position to said locked position.

5. The combination recited in claim 4, wherein said locking head position control is a lever arm attached to said locking bolt and projecting outwardly from the body of said coupler at which to receive said rotational force thereagainst.

6. The combination recited in claim 4, wherein the body of said coupler includes first and second body portions adapted to be moved from an open position lying apart from one another to a closed position coupled to one another and lying in surrounding engagement with said locking bolt.

7. The combination recited in claim 6, wherein the first and second body portions of said coupler body are pivotally connected to one another at a hinge therebetween, whereby said first and second body portions are rotatable at said hinge between said open and closed positions.

8. The combination recited in claim 6, wherein each of the first and second body portions of said coupler body includes a cradle within which to receive said locking bolt, said locking bolt being rotatable within the respective cradles of said first and second body portions in response to the rotational force applied against the locking head position control when said first and second body portions are rotated to said closed position.

9. The combination recited in claim 1, wherein the locking end of said insert has an opening formed therein, the locking head of said coupler being moved through said opening at which to be rotated with respect to said locking end from said unlocked position to said locked position in response to the operation of said locking head position control so as to cause said coupler to be mated to said insert.

10. The combination recited in claim 9, wherein said insert has a hollow interior, said locking end extending across said hollow interior, and said opening being formed in said locking end and communicating with said hollow interior, the locking head of said coupler moving through the opening in said locking end so as to rotate from said unlocked position to said locked position at the hollow interior of said insert.

11. A combination, comprising:
a first panel;
a second panel;
a coupler connected to said first panel, said coupler including a coupler body, a locking bolt rotatable within said coupler body, a locking head rotatable with said locking bolt, and a force-transmitting arm communicating with said locking bolt; and
an insert connected to said second panel, said insert having a locking end at which to receive the locking head of said coupler when said coupler is moved towards and into engagement with said insert and a rotational force is applied to the force-transmitting arm of said coupler to cause said locking bolt to rotate within said coupler body and said locking head to correspondingly rotate with respect to the locking end of said insert from an unlocked position to a locked position, whereby said locking head is captured by said locking end and said coupler is thereby mated to said insert so that said first and second panels are joined to one another without the use of tools.

12. The combination recited in claim 11, wherein the locking end of said insert has an opening formed therein, the locking head of said coupler being moved through said opening at which to be rotated with respect to said locking end from said unlocked position to said locked position in response to the rotational force applied to the force-transmitting arm of said coupler so as to cause said coupler to be mated to said insert.

13. The combination recited in claim 12, wherein said insert has a hollow interior, said locking end extending across said hollow interior, and said opening being formed in said locking end and communicating with said hollow interior, the locking head of said coupler moving through the opening in said locking end so as to rotate from said unlocked position to said locked position at the hollow interior of said insert.

14. The combination recited in claim 11, wherein the locking head of said coupler that is rotatable with said locking bolt is located inwardly of the body of said coupler, said locking bolt sliding through the body of said coupler in response to the application of an axial pushing force to the force-transmitting arm which communicates with said locking bolt, whereby to cause said locking head to correspondingly move outwardly from said coupler body at which to be rotated from said unlocked position to said locked position after said coupler is moved towards and into engagement with said insert.

15. The combination recited in claim 11, wherein the body of said coupler includes first and second body portions adapted to be moved from an open position lying apart from one another to a closed position coupled to one another and lying in surrounding engagement with said locking bolt so that said locking bolt is rotatable within said coupler body.

16. The combination recited in claim 11, wherein the locking head of said coupler has a cam shoulder which rotates against the locking end of said insert by which to pull said insert towards said coupler when said coupler is moved towards and into engagement with said insert and said rotational force is applied to the force-transmitting arm of said coupler to cause said locking bolt to rotate within said coupler body.
